(19) United States
(12) Patent Application Publication
(10) Pub. No.: US 2026/0134274 A1
(43) Pub. Date: May 14, 2026

(54) MIXTURE OF EXPERTS NETWORK TO DETERMINE TEXT DATA SOURCE

(71) Applicant: INTERNATIONAL BUSINESS MACHINES CORPORATION, ARMONK, NY (US)

(72) Inventors: Zhong Fang Yuan, Xi'an (CN); Yuan Yuan Ding, Shanghai (CN); Tong Liu, Xi'an (CN); Li Juan Gao, Xi'an (CN)

(21) Appl. No.: 18/944,102

(22) Filed: Nov. 12, 2024

(51) Int. Cl. G06N 3/08; G06F 40/205; G06F 40/30; G06N 3/045

(52) U.S. Cl. CPC G06N 3/08; G06F 40/205; G06F 40/30; G06N 3/045

(57) ABSTRACT

A computer-implemented method, computer program product, and computer system that trains a transformer machine learning model using each cluster n of N clusters as training data to generate a trained transformer n which is a machine learning model that is an expert n (n=1, . . . , N). The N experts are respectively associated with the N clusters. N is at least 2. The N trained transformers together form the MoE network. The N clusters are derived from input text.

### BACKGROUND

The present invention relates to machine learning for generative models, training such generative models, and machine learning for tracing the source of data used to train generative models.

### SUMMARY

Embodiments of the present invention provide a computer-implemented method, a computer program product, and a computer system. A transformer machine learning model is trained using each cluster n of N clusters as training data to generate a trained transformer n which is a machine learning model that is an expert n (n=1, . . . , N), wherein the N experts are respectively associated with the N clusters, wherein N is at least 2, wherein the N trained transformers together are the N experts that form the MoE network, and wherein the N clusters are derived from input text.

### BRIEF DESCRIPTION OF THE DRAWINGS

FIG. 1 is a flow chart describing a method of generating and using a Mixture of Experts (MoE) network, in accordance with embodiments of the present invention.

FIG. 2A is a flow chart describing generation of N clusters from input text, in accordance with embodiments of the present invention.

FIG. 2B illustrates steps in FIG. 2A which collectively combine consanguineous dense vectors, prosodic dense vectors, and semantic dense vectors into composite dense vectors, followed by clustering the composite dense vectors into N clusters denoted as C1, C2, . . . , CN, in accordance with embodiments of the present invention.

FIG. 3A provides an example which illustrates segmenting the input text into text units of paragraphs, in accordance with embodiments of the present invention.

FIG. 3B provides an example which illustrates segmenting the input text into text units of sentences, in accordance with embodiments of the present invention.

FIG. 4A is a flow chart describing a process for generating, from the N clusters, a Mixture of Experts (MoE) network comprising N experts respectively associated with the N clusters, in accordance with embodiments of the present invention.

FIG. 4B illustrates jointly training a large language model (LLM) network and the MoE network, using input text as a source of training data for both the LLM network and the MoE network, in accordance with embodiments of the present invention.

FIG. 5 describes a process for training a transformer model, using a cluster as training data, to generate an expert associated with the cluster, in accordance with embodiments of the present invention.

FIG. 6 is a flow chart describing how to determine a data source of a given text unit with high probability using the trained MoE network, in accordance with embodiments of the present invention.

FIG. 7 illustrates a computer system, in accordance with embodiments of the present invention.

FIG. 8 depicts a computing environment which contains an example of an environment for the execution of at least some of the computer code involved in performing the inventive methods, in accordance with embodiments of the present invention.

### DETAILED DESCRIPTION

According to a first aspect of the invention, a computer-implemented method of training a transformer machine learning model using each cluster n of N clusters as training data to generate a respective trained transformer n which is a machine learning model that is an expert n (n=1, . . . , N), wherein the N experts are respectively associated with the N clusters, wherein N is at least 2, wherein the N trained transformers together form a Mixture of Experts (MoE) network, and wherein the N clusters are derived from input text.

The preceding first aspect of the invention advantageously trains a transformer model to generate a Mixture of Experts (MoE) network comprising N experts that are specific to N respective clusters, which enables each expert to specialize in the particular features of the respective cluster.

According to a second aspect of the invention, the N clusters are generated via: (i) segmenting the input text into text units; (ii) generating semantic dense vectors by: extracting semantic features from each text unit, and for each text unit, encoding the semantic features into semantic dense vectors using an encoder portion of a large language model; (iii) generating consanguineous dense vectors by: extracting consanguineous features from each text unit, and for each text unit, encoding the consanguineous features into consanguineous dense vectors using the encoder portion of the large language model; (iv) generating prosodic dense vectors by: extracting prosodic features from each text unit, generating a one-hot vector for each prosodic feature of each text unit, and for each text unit, generating prosodic dense vectors by a fully connected network using the one-hot vectors; (v) for each text unit, computing composite dense vectors as weighted summations of the semantic dense vectors, the consanguineous dense vectors, and the prosodic denser vectors; and (vi) clustering the composite dense vectors of all text units into the N clusters and associating the N clusters with a number of respective data sources, wherein the number of respective data sources that are unique is equal to or less than N.

The preceding second aspect of the invention advantageously generates clusters which (i) comprise dense vectors with associated semantic, consanguineous, and prosodic features and (ii) are linked to respective data sources.

According to a third aspect of the invention, the MoE network is an external adapter of a large language model (LLM) network, and the method comprises: jointly (i) training the generative language machine learning model using the input text as training data and (ii) performing said training the transformer model using each cluster n as training data (n=1, . . . , N)

The preceding third aspect of the invention advantageously performs a joint training of the LLM network and the N transformer models using input text as initial inputs, which enhances an ability of the LLM network and the MoE network to jointly process input text.

According to a fourth aspect of the invention, the joint training comprises: determining a first loss of the LLM network and an MoE loss of the MoE network; computing a total loss equal to the first loss+α*MoE loss, wherein a is a specified constant in a range of 0.005 to 0.10; and incorporating the total loss into both said training the generative language machine learning model and said training the transformer model.

The preceding fourth aspect of the invention advantageously achieves the advantages of: (i) for the LLM network, the total loss influences optimizing the LLM network by including the MoE loss, which helps the LLM network to remain sensitive to cluster-specific features by adapting the parameters of the LLM network slightly towards the clusters' distinguishing characteristics and (ii) for the MoE network, the MoE loss directly affects each expert within the MoE network based on the cluster assignments, and by including the LLM loss within the total loss calculation, the training of the MoE network encourages the MoE network to retain alignment with broader language modeling objectives while refining the cluster-specific focus of the MoE network.

According to a fifth aspect of the invention, the method further comprises: selecting, by the one or more processors, the N experts via: (i) receiving a given text unit; (ii) generating, from the given text unit, a composite dense vector of features that exist in the given text unit; (iii) computing a distance between the composite dense vector and the centroid of each cluster of the N clusters, which generates N distances respectively associated with the N experts; (iv) performing a logistic operation, on each distance of the N distances, which generates N logistic distances respectively associated with the N experts denoted as expert 1, . . . , expert N; and (v) selecting, from the N experts, expert n1 having the minimum logistic distance D_{logistic_min} of the N logistic distances, wherein n1 is 1, . . . , or N.

The preceding fifth aspect of the invention advantageously selects the exert having the highest probability of being associated with the composite dense vector derived from the given text unit.

According to a fifth aspect of the invention, the method further comprises: determining, by the one or more processors, that D_{logistic_min} is less than a specified logistic distance threshold distance D_{logistic_th} and in response: identifying, by the one or more processors, the data source n1 associated with the cluster n1 as the most probable data source of the given text unit.

The preceding fifth aspect of the invention advantageously identifies the most probable data source of the given test unit.

According to a seventh aspect of the invention, the text data collectively comprises multiple text units, the training data in each cluster n (n=1, . . . , N) comprises multiple dense vectors respectively associated with the multiple text units, wherein each dense vector is based on a presence or absence of features within the multiple text units to which the multiple dense vectors are associated, and wherein the features comprise a plurality of prosodic features.

The preceding seventh aspect of the invention advantageously includes, in the training data of each cluster, the most immutable elements of language, namely prosodic features.

According to an eighth aspect of the invention, the features further comprise one or more consanguineous features, one or more semantic features, or combinations thereof.

The preceding eighth aspect of the invention advantageously includes consanguineous and/or semantic features in addition to the prosodic features, which enhance the quality of features in the training data of each cluster.

Generative language machine learning models have a scope that includes large language models (LLMs). Thus, discussions herein of usage of LLMs in embodiments of the present invention are generally applicable to generative language machine learning models.

Currently, large language models (LLMs) are widely applied across various industries. However, as LLM usage becomes more prevalent, certain irregularities are coming to the forefront, which involves many organizations and individual developers who employ a controversial approach, namely using third-party large language models to “distill” or extract valuable instructional data and then apply such instructional data to their own large language model training. This controversial approach, which conveniently acquires high-quality instructional data, also raises a series of severe intellectual property (IP) infringement concerns.

In some ways, this controversial approach is similar to acquiring unauthorized information illegally, creating potential financial losses and unfair competition for the creators of the original large language models. This situation raises many legal and ethical issues, and measures need to be taken to safeguard the legality of intellectual property rights and the principle of fair competition. Another concern is that due to the lack of adequate traceability of data in the dissemination process, this practice may lead to the spread of Artificial Intelligence (AI) “fake news” and AI “disinformation”. This information may be misused or abused, which may have a negative impact on society and undermine the credibility and reliability of public information.

Therefore, embodiments of the present invention provide an innovative solution, similar to the concept of isotopes in the physical world, to track and trace the flow of data, so as to ensure that the source of data can be traced and reduce the spread of disinformation. This “digital isotope” method can act as a tracer analysis, similar to tracking and tracing of substances in the real world, to ensure the legitimacy and credibility of the data and to protect intellectual property rights and the credibility of information to maintain order and sustainability in the digital world.

Thus, embodiments of the present invention encode digital isotopes of data in a large language model using the idea of textual prosody statistics, which takes advantage of the most immutable element of language, namely prosody, which will likely exist in any kind of text-centric data, and as the data changes and flows, this prosody element will not be severely affected.

Accordingly, embodiments of the present invention add a prosodic mapping discriminant task to the original training task in accordance with the following steps (a)-(d).
(a) Prosodic processing is performed for all text training data, and prosodic features from the dimensions of Rhyme, Meter, Beat, Tone, Homophones, etc., are used to form a prosody feature set of prosody.
(b) Based on the prosodic feature set, on added semantic features, and on added consanguineous features, a clustering of the original data set is performed, and the original data set is automatically divided into multiple subsets with significantly different prosodic features.
(c) For different subsets of the original data set, sequence regression is used to model each dimension of prosody, and a final fusion is carried out to obtain a Mixture of Expert (MoE) network that can fit the prosody characteristics of the different subsets. The MoE network can determine which prosodic feature set the text belongs to from a prosodic point of view.
(d) For different texts to be tested, the MoE network can be used to trace the source of the text to be tested in the large language model training set from the perspective of the relevant prosodic feature.

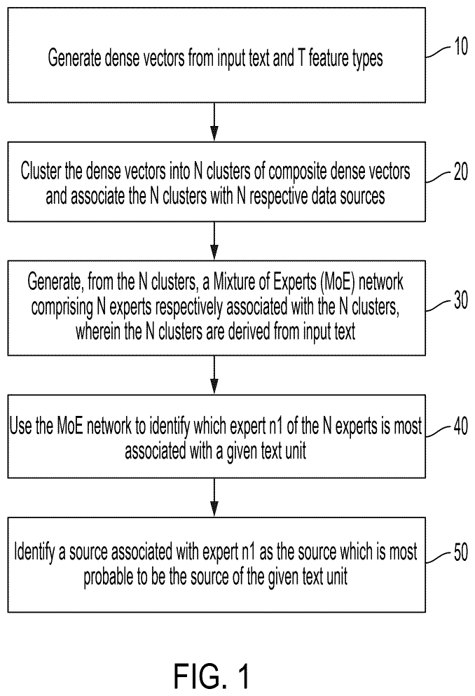

FIG. 1 is a flow chart describing a method of generating and using a Mixture of Experts (MoE) network, in accordance with embodiments of the present invention. The flow chart of FIG. 1 includes steps 10-50.

Step 10 generates dense vectors from input text and T feature types, wherein T is at least 1.

The input text may be, for example, a document of text, which may include paragraphs of text, sentences of text, phrases of text, words of text, or combinations thereof.

The input text includes T features, such as, inter alia, the three features (T=3) of prosodic features, consanguineous features, and semantic features.

The dense vectors are encoded with the features found in the input text.

Prosodic features are features that result from combining sounds in connected elements of text in a way that contributes to meaning and communication.

Prosodic features may include, inter alia, some or all of the prosodic features listed in Table 1.

TABLE 1
Prosodic Features

| | Prosodic | |
|---|---|---|
| Category | Feature | Example (EX) and/or Description (DE) |
| Rhyme | End rhyme | EX: She had a cat and a hat |
| Rhyme | Eye rhyme | DE: rhyming in spelling but not in |
| | | pronunciation |
| | | EX: Love and prove |
| Rhyme | Internal rhyme | EX: Once upon a midnight dreary, |
| | | while I pondered, weak and weary |
| Meter | Iambic meter | EX: To be or not to be, that is the |
| | | question |
| Meter | Trochaic meter | EX: Peter, Peter, pumpkin eater |
| Meter | Anapestic meter | EX: 'Twas the night before Christmas |
| Meter | Dactylic meter | EX: Hickory, dickory, dock |
| Beat | Beat | DE: Rhythmic patterns in music, such |
| | | as the strong and weak beats in a 4/4 |
| | | time signature |
| Tone | Tone | DE: Intonation patterns in spoken |
| | | English, including rising and falling |
| | | tones, can create rhythm |
| Homophones | Homophones | DE: For example, “they're,” “their,” |
| | | and “there” sound the same but |
| | | have different meaning |
| Alliteration | Alliteration | EX: She sells seashells by the seashore |
| Assonance | Assonance | EX: hear the mellow wedding bells |

Consanguineous features are metadata indicating, for example, the source of the data (e.g., databases, files, sensors, etc.). Example of consanguineous features are listed in Table 2.

TABLE 2
Consanguineous Features

| Consanguineous Feature | Description |
|---|---|
| Name of the data set | |
| Concise classification of | |
| the data | |
| Data collection time | The collection or generation time stamp |
| | of data, which records when the data |
| | was created or captured |
| Data producer | Information identifying the creator or |
| | producer of data, usually the name of |
| | an individual or organization |
| Data transfer path | The path from production to storage or |
| | distribution |
| Data modification history | |
| Data storage location | |
| Data usage record | |

Semantic features pertain to the meanings and relationships conveyed by the words and phrases in a sentence or document. The semantic features help in understanding the content beyond its literal form, focusing on what the text actually signifies.

Step 20 clusters the dense vectors into N clusters of composite dense vectors and associates the N clusters with N respective data sources, wherein N is at least 2.

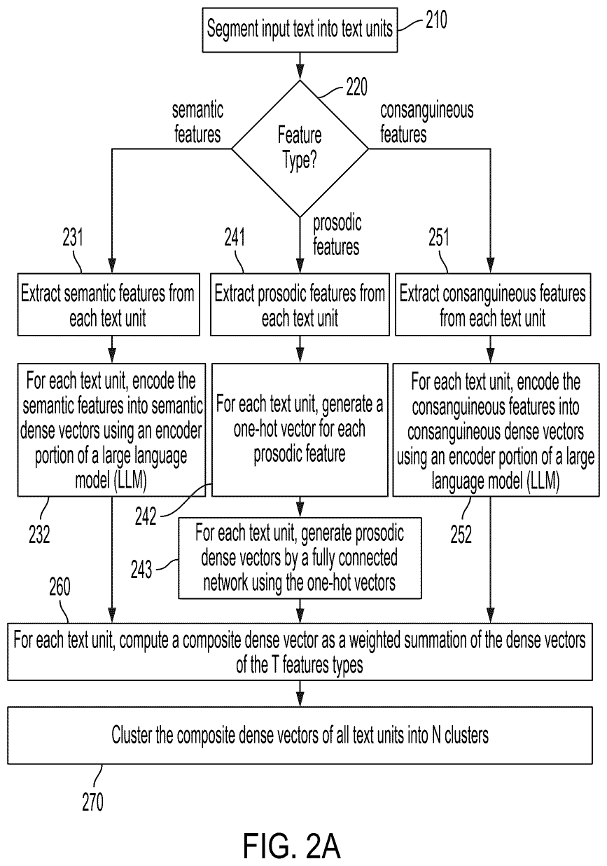

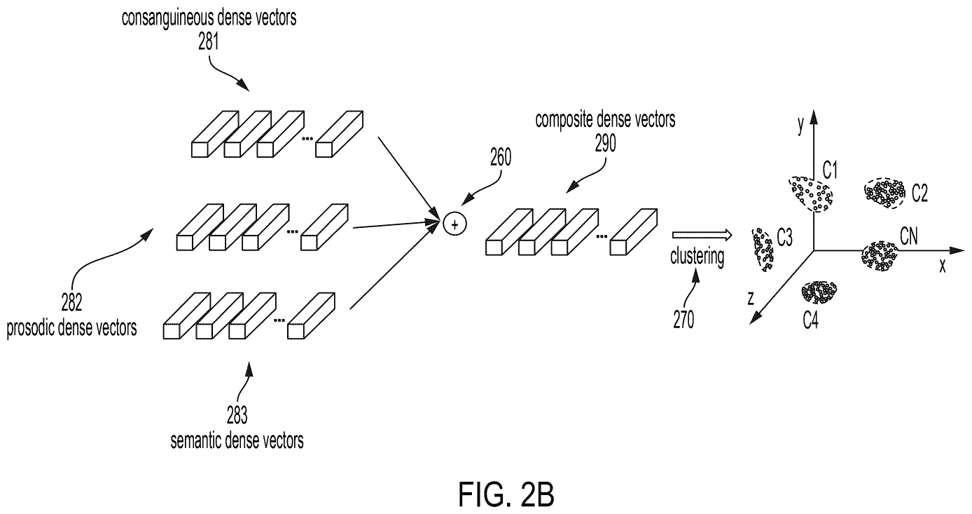

Steps 10 and 20 are described in detail in FIGS. 2A and 2B.

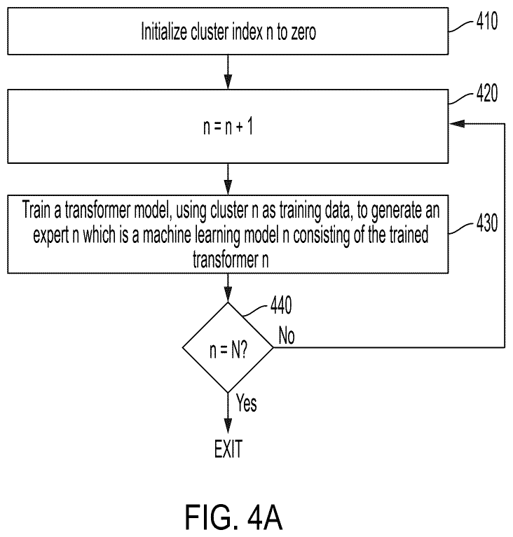

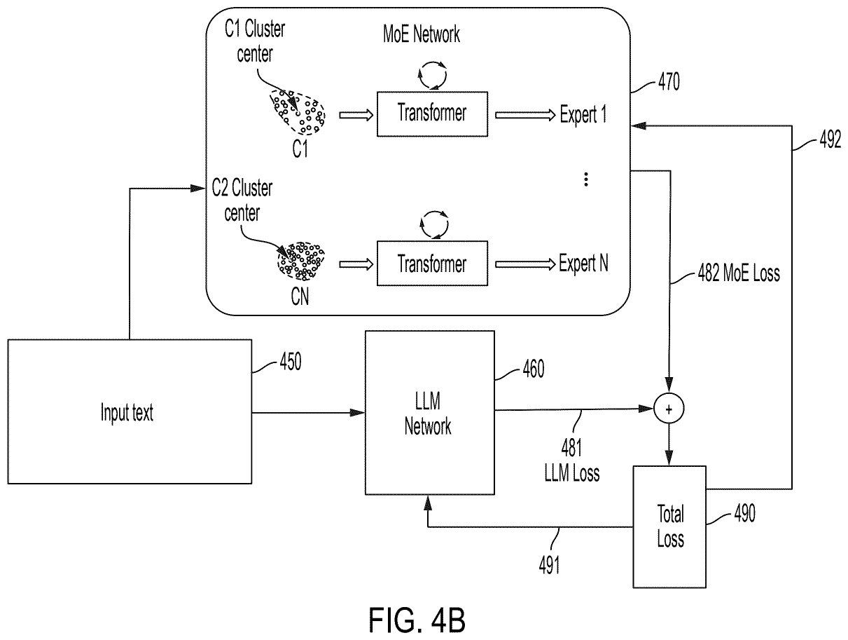

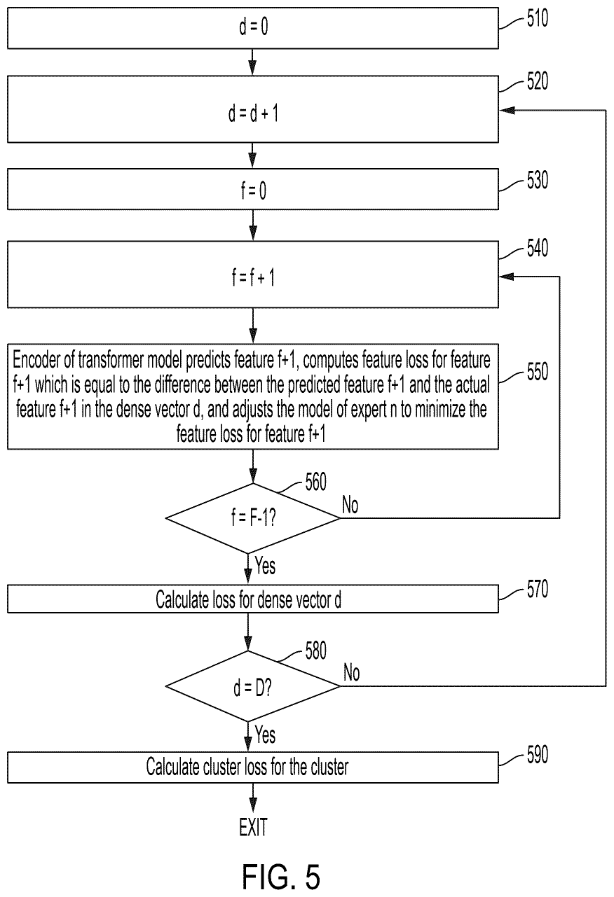

Step 30 generates, from the N clusters, a Mixture of Experts (MoE) network comprising N experts respectively associated with the N clusters, wherein the N clusters are derived from input text. Step 30 is described in detail in FIGS. 4A, 4B and 5.

Step 40 uses the MoE network to identify which expert n1 of the N experts is most associated with a given text unit, wherein n1 is selected from the group consisting of 1, . . . , N.

Step 50 identifies a source associated with expert n1 as the source which is most probable to be the source of the given text unit.

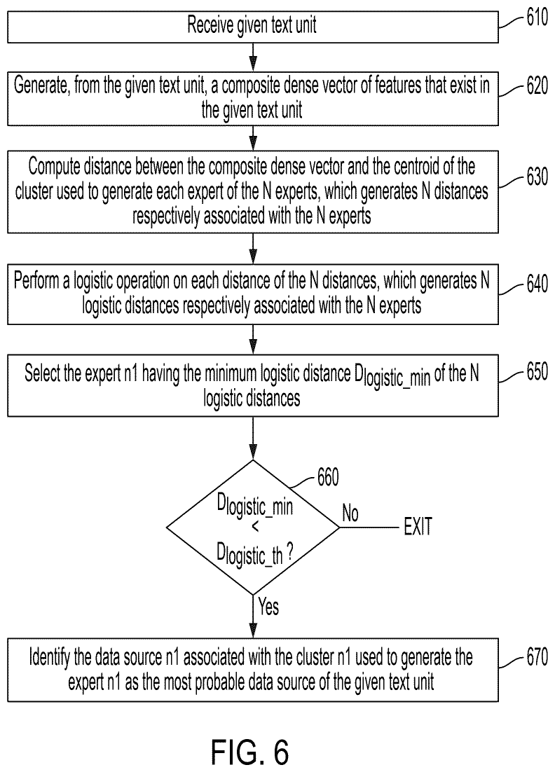

Steps 40 and 50 are described in detail in FIG. 6.

FIG. 2A is a flow chart of a process describing generation of the N clusters from the input text, in accordance with embodiments of the present invention.

FIG. 2A, which includes steps 210-270, describes steps 10 and 20 in FIG. 1 in detail.

Step 210 segments the input text into text units. Text units may be, inter alia, paragraphs, sentences, phrases, etc. The text units include prosodic features, semantic features, and/or consanguineous features.

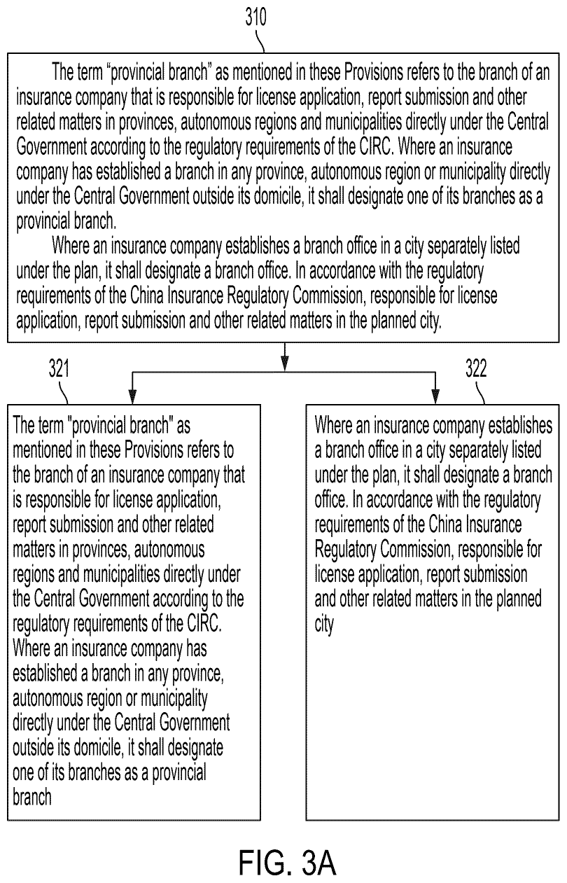

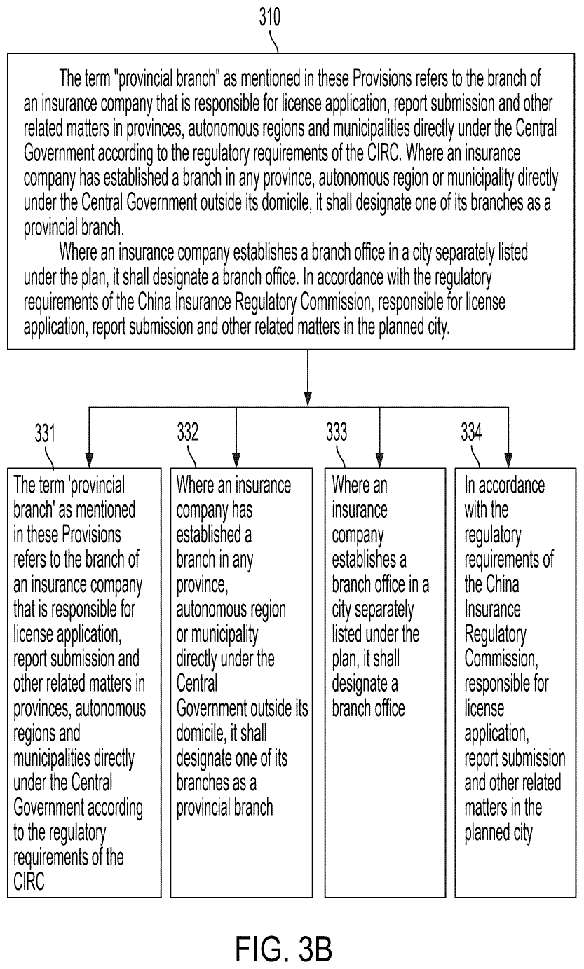

FIG. 3A provides an example which illustrates segmenting the input text 310 into text units of paragraphs 321 and 322, in accordance with embodiments of the present invention.

FIG. 3B provides an example which illustrates segmenting the input text 310 into text units of sentences 331, 332, 333, and 334, in accordance with embodiments of the present invention.

Step 220 decides on logic paths for generating dense vectors. The logic paths are: steps 231-232, steps 241-243, and steps 251-252 for processing: semantic features to generate semantic dense vectors, prosodic features to generate prosodic dense vectors, and consanguineous features to generate consanguineous dense vectors, respectively.

With respect to consanguineous features, step 251 extracts consanguineous features from each text unit. To perform this extraction, in some embodiment metadata that accompanies a text is obtained and parsed to obtain consanguineous features from text.

Step 252 encodes the consanguineous features into dense vectors using an encoder portion of a large language model (LLM), with each dense vector being specific to a text unit.

As an example, consider a sentence as a text unit from which the following consanguineous features have been extracted in a format of (feature: feature value): Data source: External API; Data collection time: 2023-09-28 10:35:00; Data producer: OpenAI API; Data transfer path: API to Database; Data modification history: No modifications; Data storage location: Cloud Storage; Data usage record: Queried 5 times.

These preceding consanguineous features are passed through the encoder, which transforms the consanguineous features into a dense vector having real number values therein; e.g., [0.34, 0.58, 0.12, 0.76, 0.19, 0.09, 0.45, . . . ].

With respect to semantic features, step 231 extracts semantic features from each text unit. At least some embodiments of the present invention use an embedding model to directly convert semantic features and consanguineous features of textual natural language to an embedding vector.

Step 232 encodes the semantic features into semantic dense vectors using an encoder portion of a large language model (LLM), with each dense vector being specific to a text unit.

As an example, the semantic dense vector generated by the encoder may have the following form: [0.45, 0.23, 0.81, . . . ].

With respect to prosodic features, step 241 extracts prosodic features from each text unit.

Step 242 generates, for each text unit, a one-hot vector for each prosodic feature.

As an example, consider a sentence as a text unit from which the following prosodic features have been extracted (YES means extracted; No means not extracted): (i) End rhyme: No; Eye rhyme: No; Internal rhyme: Yes; one-hot vector (0, 0, 1); (ii) meter: No for each of 4 meter features; one-hot vector (0, 0, 0, 0); (iii) beat tone, homophones, alliteration, assonance: No for each; 5 one-hot values 0; (iv) final one-hot vector text unit of the sentence: (0, 0, 1), (0, 0, 0, 0), 0, 0, 0, 0, 0.

Step 243 generates, for each text unit, prosodic dense vectors using a fully connected network and the one-hot vectors as input to the fully-connected network that had been trained to generate dense vectors using the one-hot vectors as input, with each dense vector being specific to a text unit.

The semantic dense vectors, the prosodic dense vectors, and the consanguineous dense vectors are vectors of real numbers, with each dense vector having a same embedding size.

Step 260 computes, for each text unit, a composite dense vector as a weighted summation of the dense vectors over the T feature types, as illustrated in Equation (1) in which weights w1, w2, and w3 satisfy: 0≤w1≤1, 0<w2<1, 0<w3<1, w1+w2+w3=1.

$$Composite DV = w 1 * prosodic DV + w 2 * consanguineous DV + w 3 * semantic DV \qquad ( 1 )$$

In Equation (1), DV stands for dense vector.

For example, w1, w2, and w3 may have values of: w1=0.5, w2=0.3, and w3=0.2.

In different embodiments, w2 may be zero, w3 may be zero, or both w2 and w3 may be zero.

In all embodiments, w1 is a positive real number.

Step 270 clusters the composite dense vectors of all text units into N clusters by performing a clustering algorithm such as K-means, DBSCAN, etc. Each cluster includes multiple composite dense vectors, with each composite dense vector being specific to a text unit. Thus, different composite dense vectors in a cluster may be specific to different text units, because all of the composite dense vectors in a cluster share significantly similar prosodic features, consanguineous features, and/or semantic features.

After each cluster n of the N clusters has been formed, a data source n is identified, wherein the data source n has the same or significantly similar prosodic features, consanguineous features, and/or semantic features as the cluster n (n=1, . . . , N), so that the N clusters are respectively associated with N data sources.

The N data sources to which the N clusters are respectively associated are determined by applying the process of FIG. 2A to each data source of M different data sources as follows, wherein M is at least 2, and wherein each data source of the M different data sources includes source text.

The process of FIG. 2A is executed for each data source m by modifying step 210 to segment the source text in data source m into text units instead of segmenting the input text into text units, resulting in step 270 generating multiple source clusters for each data source m (m=1, . . . , M). The number of generated source clusters may vary among the different data sources as a function of the source text in each data source m and values of parameters in the clustering algorithm (K-means, DBSCAN, etc.) used to form the multiple source clusters for data source m. Let S denote the total number of source clusters generated for all of the M data sources collectively.

After the process of FIG. 2A has been executed for all of the M data sources, each cluster n of the N clusters is matched against each source cluster in a subset of the S source clusters (where the subset may encompass all of the S source clusters in one embodiment) to find a match based on a similarity measure such as Euclidean distance or cosine similarity. Upon finding a match between cluster n and one source cluster of one data source of the S data sources, cluster n is associated with the one data source. Thus, a data source matching each cluster n (n=1, . . . , N) has been found, and the N clusters are respectively associated with the N data sources that have been found. The N data sources are used in step 670 of FIG. 6, described infra, to determine a most probable data source of input text. Data sources of the M data sources not found to match any of the N clusters are not subsequently used in the implementation of embodiments of the present invention. For example, if M=30 and N=10, the 10 found data sources of the 30 data sources are used in step 670 of FIG. 6, and the remaining 20 data sources of the 30 data sources are not subsequently used. In an alternative scenario if the number of actual data sources M is less than the number of identified clusters N (e.g., M=20 and N=25), then the MoE network still functions, but five clusters of the N clusters (i.e., 25 clusters) are not associated with any data source M. In this alternative scenario, if during inference a new given text sample matches with one of the unassociated clusters (e.g., matches with one of the five unassociated clusters for the M=20 and N=25 example), the system produces a blank output (e.g., no identified associated data source). The system with N greater than M still can produce an associated data source match for a new given input data text that matches to one of the clusters that has an associated data source (e.g., can still produce a data source match for 20 clusters).

FIG. 2B illustrates steps 260 and 270 in FIG. 2A which collectively combine (step 260) consanguineous dense vectors 281, prosodic dense vectors 282, and semantic dense vectors 283 into composite dense vectors 290, followed by clustering (step 270) the composite dense vectors into N clusters denoted as C1, C2, . . . , CN, in accordance with embodiments of the present invention.

FIG. 4A is a flow chart describing a process for generating, from the N clusters, a Mixture of Experts (MoE) network comprising N experts respectively associated with the N clusters, in accordance with embodiments of the present invention. FIG. 4A, which includes steps 410-440, describes step 30 of FIG. 1 in more detail.

Step 410 initializes a cluster index n to zero.

Steps 420-440 define a loop of an iterative process that iterates over the clusters of the N clusters.

Step 420 increment n by 1

Step 430 trains a transformer model n using cluster n as training data to generate an expert n, which is a machine learning model n, consisting of the trained transformer n, where n is one of: 1, . . . , N. Only an encoder portion of the transformer model is utilized in step 430.

The transformer model is a neural network that learns the context of sequential data from which the transformer model generates new data.

The transformer model has a self-attention mechanism, which allows the transformer model to process input data more efficiently and capture long-range dependencies in sequences without relying on recurrence, in contrast with traditional recurrent neural networks (RNNs). The self-attention mechanism calculates the relevance of each token, where a token may be a word, in a sequence of tokens relative to the other tokens in the sequence, which enables the transformer model to understand contextual relationships between tokens irrespective of the distance between tokens in the sequence. The transformer model uses several self-attention layers in parallel to process all tokens in parallel, allowing the transformer model to focus on different parts of the sequence simultaneously and capture a richer set of relationships. The encoder portion trained in step 430 includes the self-attention mechanism; e.g., as described above.

The encoder portion of the transformer model transforms the input tokens into contextualized representations. Unlike earlier models that processed tokens independently, the transformer encoder captures the context of each token with respect to the entire sequence of tokens.

Given a sequence of features in a dense vector of cluster n, the machine language model of each expert n predicts a next feature f+1 from a present feature f and previous features f−1, f−2, . . . in the sequence of features.

Step 430 is described in detail in FIG. 5.

Step 440 determines whether n=N. If so (Yes branch from step 440) then the process of FIG. 4A ends, and if not (No branch from step 440) then the process loops back to step 420 to perform the next iteration n+1.

FIG. 4B illustrates jointly training a large language model (LLM) network 460 and the MoE network 470, using input text 450 as a source of training data for both the LLM network 460 and the MoE network 470, in accordance with embodiments of the present invention.

The LLM network 460 computes an LLM loss 481 which is minimized via backpropagation configured to adjusts weights and/or parameters of the LLM 460, and the MoE network 470 computes an MoE loss 482 which is minimized via backpropagation configured to adjusts weights and/or parameters of the MoE network 470, which focusses on optimizing each expert in the MoE network 470 based on cluster-specific features, which are combined in Equation (2) to compute a Total Loss 490.

$$Total loss = LLM loss + α * MoE loss \qquad ( 2 )$$

The parameter α weights the MoE loss 482 relative to the LLM loss 481 and is a real number in a range of 0.005<α<0.100. In one embodiment, α=0.10.

The MoE loss 482 for the MoE network 470 is a composite cluster loss which is computed as a summation of the cluster loss over the clusters 1 to N.

Calculation of the cluster loss of a cluster is computed in step 590 in FIG. 5.

The total loss 490 is incorporated into both training the LLM network 460 and training the MoE network 470 via feedback paths 491 and 492, respectively.

For the LLM network 460, the total loss 490 influences optimizing the LLM network 460 by including the MoE loss 482, which helps the LLM network 460 to remain sensitive to cluster-specific features by adapting the parameters of the LLM network 460 slightly towards the clusters' distinguishing characteristics.

For the MoE network 470, the MoE 482 loss directly affects each expert within the MoE network 470 based on the cluster assignments. By including the LLM loss 481 within the total loss 490 calculation, the training of the MoE network 470 encourages the MoE network to retain alignment with broader language modeling objectives while refining the cluster-specific focus of the MoE network 470.

In an alternate embodiment, the MoE network 470 is trained independent of the LLM network 460 is a same manner as described supra, except that the feedback path 492 does not exist in this alternate embodiment.

FIG. 5 describes a process for training the transformer model n, using cluster n as training data, to generate an expert n associated with the cluster n, in accordance with embodiments of the present invention.

FIG. 5, which includes steps 510-590, describes step 430 of FIG. 4A in more detail.

Transformer model n is any one of the transformer models n such that (n=1, . . . , N). Cluster n includes D dense vectors, and each dense vector includes F features wherein F may vary among the dense vectors.

Step 510 initializes a dense vector index d to zero.

Steps 520-580 define an outer loop over the dense vectors 1 to D.

Step 520 increments d by 1.

Step 530 initializes a feature index f to zero.

Steps 540-560 define an inner loop over features 1 to F.

Step 540 increments f by 1.

In step 550, the encoder of the transformer model predicts feature f+1, computes the feature loss for feature f+1 which is equal to the difference between the predicted feature f+1 and the actual feature f+1 in the dense vector d, and adjusts the model (e.g., adjusts weights and/or parameters of the model; e.g., via backpropagation) of expert n to minimize the feature loss for feature f+1.

The prediction of feature f+1 is based on the current feature f and previous features f−1, f−2, . . . .

Step 560 determines whether f=F−1. If so (Yes branch from step 560) then step 570 is next executed, and if not (No branch from step 560) then processing loops back to step 540 to process the next feature f+1.

Step 570 calculates the dense vector loss for dense vector d.

In one embodiment, the dense vector loss for dense vector d is equal to a sum over the feature losses of the F features, where the feature loss of each feature f was computed in step 550.

In one embodiment, the dense vector loss for dense vector d is equal to the magnitude of the difference between the dense vector d and the centroid dense vector of the cluster n.

Step 580 determines whether d=D. If so (Yes branch from step 580) then step 590 is next executed, and if not (No branch from step 580) then processing loops back to step 520 to process the next dense vector d+1.

Step 590 calculates the cluster loss for the cluster n which is equal to a sum over the dense vector losses of the D dense vectors, where the dense vector loss of each dense vector d was computed in step 570. As discussed supra in conjunction with FIG. 4B, the cluster loss for the cluster n is used to calculate the MoE loss 482 for the MoE network 470, wherein the MoE loss 482 is a composite cluster loss that is computed as a summation of the cluster loss n over the clusters 1 to N.

Thus, the MoE structure enables the transformer model to specialize for different clusters. For example, expert n is specifically tuned on the data from cluster Cn and learns the nuanced relationships between the features unique to cluster n, for each cluster n (n=1, . . . , N).

FIG. 6 is a flow chart describing how to determine a data source of a given text unit with high probability using the trained MoE network, in accordance with embodiments of the present invention. The input to the MoE network is a given text unit. The output from use of the trained MoE network is a discriminant output represented as an N-dimensional vector whose elements represent a similarity between a composite dense vector derived from the given text input and a centroid of the cluster associated with each expert of the MoE network. The LLM 460 that was involved for the joint training may be used, but is not required to be used, for the inference portion in which the trained MoE network 470 is used in step 630 of FIG. 6 to generate a discriminant output for subsequent use to perform data tracing of given text to a particular data source.

The flow chart of FIG. 6 includes steps 610-670.

Step 610 receives a given text unit as input.

Step 620 generates, from the given text unit, a composite dense vector of features that exist in the given text unit, using methodology for computing a composite dense vector described supra for FIGS. 2A and 2B including step 260 of FIG. 2A.

Step 630 is an inference step that computes, using the trained MoE network, a discriminant output which is a distance between the composite dense vector and the centroid of the cluster used to generate each expert of the experts. Thus, step 630 generates N distances respectively associated with the N experts represented as N-dimensional output vector. The smallest distances have the highest similarities between the composite dense vector derived from the given text input and the centroid of the cluster associated with each expert of the MoE network.

In one embodiment, the distance is a Euclidian distance. In one embodiment, the distance is a distance based on a cosine similarity.

Step 640 performs a logistic operation on each distance of the N distances, which generates N logistic distances respectively associated with the N experts. The logistic function converts a real-valued number x into a probability between 0 and 1 and is defined as: logistic (x)=1/(1−e^{-x}).

Step 650 selects the expert n1 (from expert 1, . . . , expert N) having the minimum logistic distance D_{logistic_min}.

Step 660 determines whether the minimum logistic distance D_{logistic_min} is less than a specified logistic distance threshold D_{logistic_th}. If so (Yes branch from step 660) then step 670 is next executed, and if not (No branch from step 660) then the process exits.

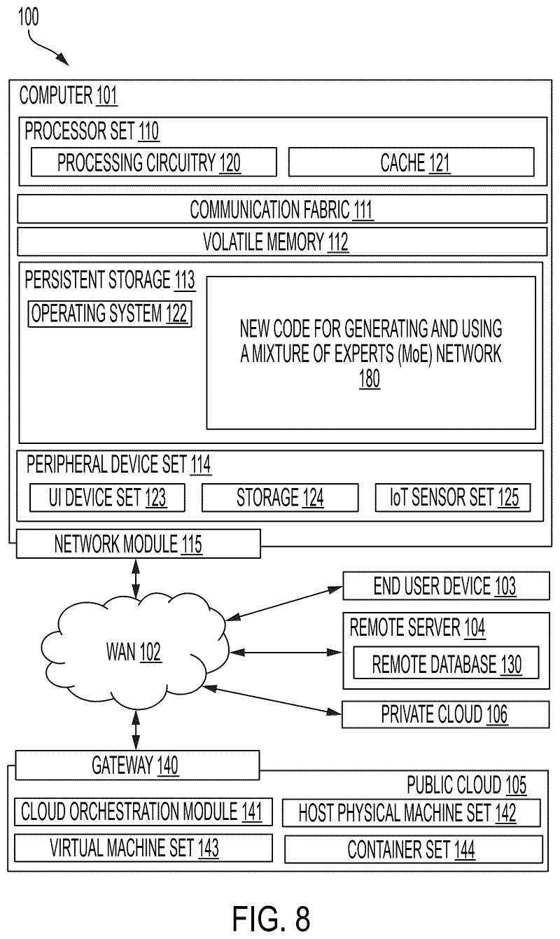

Step 670 identifies the data source n1 associated with the cluster n1 used to generate the expert n1 as the most probable data source of the given text unit. This identification occurs in various embodiments with the generation, transmittal, and presentation of a message which indicates the identified data source n1. The presentation occurs in some embodiments via visible display on a display screen of a computer such as a display screen of the UI device set 123 of the computer 101 shown in FIG. 8 and described subsequently.

As an example, consider a trained MoE network having 5 experts (N=5). The 5-dimensional output vector is: 0.58, 0.342, 0.12, 0.94, 0.74, which are the logistic distances computed in step 630. Expert 3 has the smallest logistic distance (0.12) and is therefore the expert closest to the cluster 3 whose centroid dense vector has the highest similarity with the composite dense vector derived from the given text input.

Thus, if the logistic distance 0.12 is less than the threshold logistic distance, then source 3, which is associated with cluster 3, is identified as being the most probable data source of the given text unit.

As another example, assume that there is training data from two different sources, S1 and S2, where S1 contains texts with an iambic meter (e.g., “To be or not to be”) and S2 contains texts with a trochaic meter (e.g., “Peter, Peter, pumpkin eater”).

Based on prosodic features, sources S1 and S2 are respectively clustered into distinct clusters C1 and C2, where cluster C1 corresponds to the iambic meter and cluster C2 corresponds to the trochaic meter. Clusters C1 and C2 are linked to experts E1 and E2, respectively. It is assumed in this example that N=2 (i.e., 2 experts and associated clusters)

Suppose that a third party generates a text unit which is treated as the given text unit processed in FIG. 6 using the MoE network with N=2.

The 2-dimensional output vector is: 0.23, 0.45, which are the logistic distances computed in steps 620 and 630. Expert 1 has the smallest logistic distance (0.23) and is therefore the expert closest to the cluster 1 whose centroid dense vector is closest in distance to the composite dense vector derived from the given text input.

Thus, if the logistic distance 0.23 is less than the logistic distance threshold, then source 1, which is associated with cluster 1 (iambic meter), is identified as being the most probable data source of the given text unit. A message is generated, transmitted, and presented which indicates source 1 as the most likely source of the given text unit. The message is displayed on a display screen of the UI device set 123 of the computer 101 shown in FIG. 8 and described subsequently.

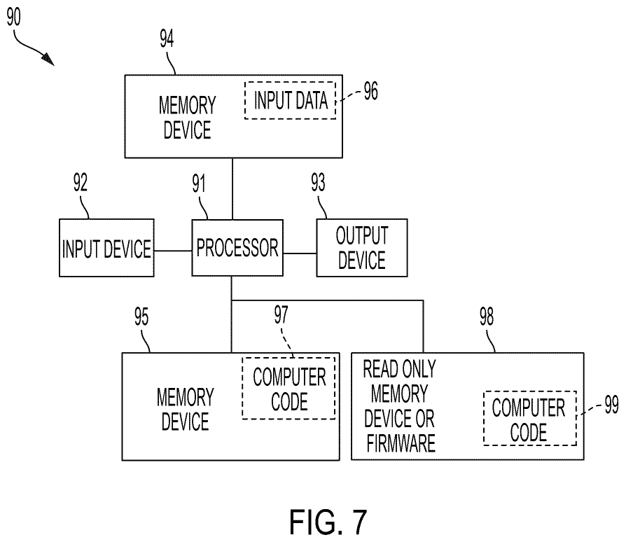

FIG. 7 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 8 depicts a computing environment 100 which contains an example of an environment for the execution of at least some of the computer code involved in performing the inventive methods, in accordance with embodiments of the present invention. Such computer code includes new code for generating and using a Mixture of Experts (MoE) network 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
training a transformer machine learning model using each cluster n of N clusters as training data to generate a respective trained transformer n which is a machine learning model that is an expert n (n=1, . . . , N), wherein the N experts are respectively associated with the N clusters, wherein N is at least 2, wherein the N trained transformers together form a Mixture of Experts (MoE) network, and wherein the N clusters are derived from input text.

2. The method of claim 1, further comprising generating the N clusters via:
segmenting the input text into text units;
generating semantic dense vectors by: extracting semantic features from each text unit, and for each text unit, encoding the semantic features into semantic dense vectors using an encoder portion of a generative language machine learning model;
generating consanguineous dense vectors by: extracting consanguineous features from each text unit, and for each text unit, encoding the consanguineous features into consanguineous dense vectors using the encoder portion of the generative language machine learning model;
generating prosodic dense vectors by: extracting prosodic features from each text unit, generating a one-hot vector for each prosodic feature of each text unit, and for each text unit, generating prosodic dense vectors by a fully connected network using the one-hot vectors;
for each text unit, computing composite dense vectors as weighted summations of the semantic dense vectors, the consanguineous dense vectors, and the prosodic dense vectors; and
clustering the composite dense vectors of all text units into the N clusters and associating the N clusters with a number of respective data sources, wherein the number of respective data sources that are unique is equal to or less than N.

3. The method of claim 1, wherein the MoE network is an external adapter of a generative language machine learning model, and wherein the method further comprises:
jointly (i) training the generative language machine learning model using the input text as training data and (ii) performing said training the transformer model using each cluster n as training data (n=1, . . . , N).

4. The method of claim 3, wherein said jointly training comprises:
determining a first loss of the generative language machine learning model and an MoE loss of the MoE network;
computing a total loss equal to the first loss+α*MoE loss, wherein a is a specified constant in a range of 0.005 to 0.10; and
incorporating the total loss into both said training the generative language machine learning model and said training the transformer model.

5. The method of claim 1, further comprising:
receiving a given text unit;
generating, from the given text unit, a composite dense vector of features that exist in the given text unit;
computing a distance between the composite dense vector and a respective centroid of each cluster of the N clusters, which generates N distances respectively associated with the N experts;
performing a logistic operation, on each distance of the N distances, which generates N logistic distances respectively associated with the N experts denoted as expert 1, . . . , expert N; and
selecting, from the N experts, expert n1 having a minimum logistic distance D_{logistic_min} of the N logistic distances, wherein n1 is 1, . . . , or N.

6. The method of claim 5, wherein the clusters 1, . . . , N are respectively associated with data sources 1, . . . , N, and wherein the method further comprises:
determining that D_{logistic_min} is less than a specified logistic distance threshold distance D_{logistic_th} and in response, identifying the data source n1 associated with the cluster n1 as a most probable data source of the given text unit.

7. The method of claim 1, wherein the text data collectively comprises multiple text units, wherein the training data in each cluster n (n=1, . . . , N) comprises multiple dense vectors respectively associated with the multiple text units, wherein each dense vector is based on a presence or absence of features within the multiple text units to which the multiple dense vectors are associated, and wherein the features comprise a plurality of prosodic features.

8. The method of claim 7, wherein the features further comprise one or more consanguincous features, one or more semantic features, or combinations thereof.

9. A computer program product comprising:
one or more computer readable storage media; and
program instructions stored on the one or more computer readable storage media to perform operations comprising:
training a transformer model using each cluster n of N clusters as training data to generate a trained transformer n which is a machine learning model that is an expert n (n=1, . . . , N), wherein the N experts are respectively associated with the N clusters, wherein N is at least 2, wherein the MoE network comprises the N experts, and wherein the N clusters are derived from input text.

10. The computer program product of claim 9, wherein the operations further comprise:
segmenting the input text into text units;
generating semantic dense vectors by: extracting semantic features from each text unit, and for each text unit, encoding the semantic features into semantic dense vectors using an encoder portion of a large language model;
generating consanguineous dense vectors by: extracting consanguineous features from each text unit, and for each text unit, encoding the consanguineous features into consanguineous dense vectors using the encoder portion of the large language model;
generating prosodic dense vectors by: extracting prosodic features from each text unit, generating a one-hot vector for each prosodic feature of each text unit, and for each text unit, generating prosodic dense vectors by a fully connected network using the one-hot vectors;
for each text unit, computing composite dense vectors as weighted summations of the semantic dense vectors, the consanguineous dense vectors, and the prosodic denser vectors; and
clustering the composite dense vectors of all text units into the N clusters and associating the N clusters with a number of respective data sources, wherein the number of respective data sources that are unique is equal to or less than N.

11. The computer program product of claim 9, wherein the MoE network is an external adapter of a large language model (LLM) network, and wherein the operations further comprise:
jointly (i) training the LLM network using the input text as training data and (ii) performing said training the transformer model using each cluster n as training data (n=1, . . . , N).

12. The computer program product of claim 11, wherein said jointly training comprises:
determining an LLM loss of the LLM network and an MoE loss of the MoE network;
computing a total loss equal to the LLM loss+α*MoE loss, wherein a is a specified constant in a range of 0.005 to 0.10; and
incorporating the total loss into both said training the generative language machine learning model and said training the transformer model.

13. The computer program product of claim 9, wherein the operations further comprise:
receiving a given text unit;
generating, from the given text unit, a composite dense vector of features that exist in the given text unit;
computing a distance between the composite dense vector and the centroid of each cluster of the N clusters, which generates N distances respectively associated with the N experts;
performing a logistic operation, on each distance of the N distances, which generates N logistic distances respectively associated with the N experts denoted as expert 1, . . . , expert N; and
selecting, from the N experts, expert n1 having the minimum logistic distance D_{logistic_min} of the N logistic distances, wherein n1 is 1, . . . , or N.

14. The computer program product of claim 13, wherein clusters 1, . . . , N are respectively associated with data sources 1, . . . , N, and wherein the operations further comprise
determining that D_{logistic_min} is less than a specified logistic distance threshold distance D_{logistic_th} and in response, identifying the data source n1 associated with the cluster n1 as the most probable data source of the given text unit.

15. A computer system comprising:
a processor set; one or more computer readable storage media; and
program instructions stored on the one or more computer readable storage media to cause the processor set to perform operations comprising:
training a transformer model using each cluster n of N clusters as training data to generate a trained transformer n which is a machine learning model that is an expert n (n=1, . . . , N), wherein the N experts are respectively associated with the N clusters, wherein N is at least 2, wherein the MoE network comprises the N experts, and wherein the N clusters are derived from input text.

16. The computer system of claim 15, wherein the operations further comprise:
segmenting the input text into text units;
generating semantic dense vectors by: extracting semantic features from each text unit, and for each text unit, encoding the semantic features into semantic dense vectors using an encoder portion of a large language model;
generating consanguineous dense vectors by: extracting consanguineous features from each text unit, and for each text unit, encoding the consanguineous features into consanguineous dense vectors using the encoder portion of the large language model;
generating prosodic dense vectors by: extracting prosodic features from each text unit, generating a one-hot vector for each prosodic feature of each text unit, and for each text unit, generating prosodic dense vectors by a fully connected network using the one-hot vectors;
for each text unit, computing composite dense vectors as weighted summations of the semantic dense vectors, the consanguineous dense vectors, and the prosodic denser vectors; and
clustering the composite dense vectors of all text units into the N clusters and associating the N clusters with a number of respective data sources, wherein the number of respective data sources that are unique is equal to or less than N.

17. The computer system of claim 15, wherein the MoE network is an external adapter of a large language model (LLM) network, and wherein the operations further comprise:
jointly (i) training the LLM network using the input text as training data and (ii) performing said training the transformer model using each cluster n as training data (n=1, . . . , N).

18. The computer system of claim 17, wherein said jointly training comprises:
determining an LLM loss of the LLM network and an MoE loss of the MoE network;
computing a total loss equal to the LLM loss+α*MoE loss, wherein a is a specified constant in a range of 0.005 to 0.10; and
incorporating the total loss into both said training the generative language machine learning model and said training the transformer model.

19. The computer system of claim 15, wherein the operations further comprise:
receiving a given text unit;
generating, from the given text unit, a composite dense vector of features that exist in the given text unit;
computing a distance between the composite dense vector and the centroid of each cluster of the N clusters, which generates N distances respectively associated with the N experts;
performing a logistic operation, on each distance of the N distances, which generates N logistic distances respectively associated with the N experts denoted as expert 1, . . . , expert N; and
selecting, from the N experts, expert n1 having the minimum logistic distance D_{logistic_min} of the N logistic distances, wherein n1 is 1, . . . , or N.

20. The computer system of claim 15, wherein clusters 1, . . . , N are respectively associated with data sources 1, . . . , N, and wherein the operations further comprise:
determining that D_{logistic_min} is less than a specified logistic distance threshold distance D_{logistic_th} and in response, identifying the data source n1 associated with the cluster n1 as the most probable data source of the given text unit.
